(19) United States
(12) Patent Application Publication
(10) Pub. No.: US 2024/0384491 A1
(43) Pub. Date: Nov. 21, 2024

(54) ADJUSTABLE PILE GUIDE

(71) Applicant: Sean Barnes, Mt. Pleasant, SC (US)

(72) Inventor: Sean Barnes, Mt. Pleasant, SC (US)

(21) Appl. No.: 18/197,781

(22) Filed: May 16, 2023

(51) Int. Cl. E02D 13/04; E02B 3/06; E02D 5/54; F16M 13/02

(52) U.S. Cl. CPC E02D 13/04; E02B 3/064; E02D 5/54; F16M 13/022

(57) ABSTRACT

A pile guide has a cylinder having a central aperture therein, and constructed and arranged to receive a pile through the central aperture of the cylinder. Opposing wings extend generally vertically, such as from a side of a floating object. Flanges of a retainer extend from opposite sides of the retainer and slide within slots in the wings to provide adjustability of the pile guide by allowing movement of the cylinder relative to the dock or other floating object. Upon positioning the cylinder with the pile in the cylinder, the retainer or retainer is fixed in place relative to the wings. The distance of the cylinder from the floating dock is set to accommodate for variable distances of piles from the floating dock or floating object.

### BACKGROUND OF THE INVENTION

Floating docks are used to provide dockage for vessels. Floating docks accommodate changes in water levels by floating in water. Other floating objects are similarly held in place in a body of water by piles. The piles are attached to floating article or dock by pile guides that permit vertical movement of the floating object or dock within the body of water but substantially prevent horizontal movement of the floating object or dock.

Piles driven into the earth are used to hold the dock in position. Piles are typically not driven with precision. There is a need for a pile guide that can be adjusted relative to the floating object and the pile to accommodate for the variable distance of the piles from the dock or other floating object.

### SUMMARY OF THE INVENTION

A pile guide has a cylinder having a central aperture therein, and constructed and arranged to receive a pile through the central aperture of the cylinder. Opposing wings extend generally vertically, such as from a side of a floating object. Flanges of a retainer extend from opposite sides of the retainer and slide within slots in the wings to provide adjustability of the pile guide by allowing movement of the cylinder relative to the dock or other floating object. Upon positioning the cylinder with the pile in the cylinder, the retainer or retainer is fixed in place relative to the wings. The distance of the cylinder from the floating dock is set to accommodate for variable distances of piles from the floating dock or floating object.

### BRIEF DRAWING DESCRIPTION

FIG. 1 is a perspective view showing an adjustable pile guide with an adjustable mounting.

FIG. 2 is a top plan view of the adjustable pile guide of FIG. 1.

FIG. 3 is a front elevation of the adjustable pile guide of FIG. 1.

FIG. 4 is a side elevation of the adjustable pile guide of FIG. 1.

FIG. 5 is the side elevation of the adjustable pile guide of FIG. 4, and shows one embodiment of mounting the adjustable pile guide to a dock.

FIG. 6 is the side elevation of the adjustable pile guide of FIG. 5, and shows one embodiment of the adjustable pile guide mounted to a dock.

FIG. 7 is a perspective view showing an adjustable pile guide with an adjustable mounting having multiple retainers for the cylinder.

FIG. 8 is a top plan view of the adjustable pile guide of FIG. 8.

FIG. 9 is a front elevation of the adjustable pile guide of FIG. 8.

FIG. 10 is a side elevation of the adjustable pile guide of FIG. 8.

FIG. 11 is the side elevation of the adjustable pile guide of FIG. 8, and shows one embodiment of the adjustable pile guide mounted to a dock.

FIG. 12 is a perspective view showing an adjustable pile guide with an adjustable mounting having multiple retainers for the cylinder and multiple wings on each side of the bracket.

FIG. 13 is a top plan view of the adjustable pile guide of FIG. 12.

FIG. 14 is a front elevation of the adjustable pile guide of FIG. 12.

FIG. 15 is a side elevation of the adjustable pile guide of FIG. 12.

FIG. 16 is the side elevation of the adjustable pile guide of FIG. 12, and showing one embodiment of the adjustable pile guide mounted to a dock.

FIG. 17 is an exploded view of an embodiment of the adjustable pile guide having multiple retainers.

### DETAILED DESCRIPTION OF PREFERRED EMBODIMENTS

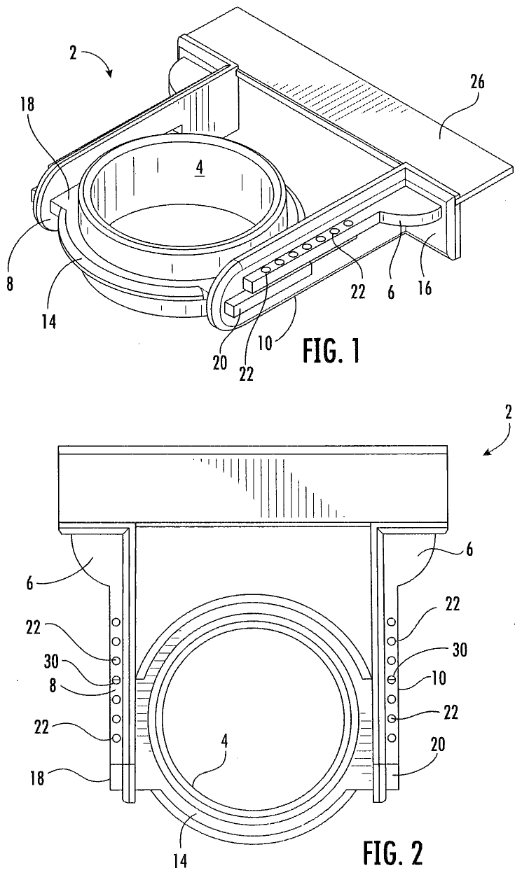

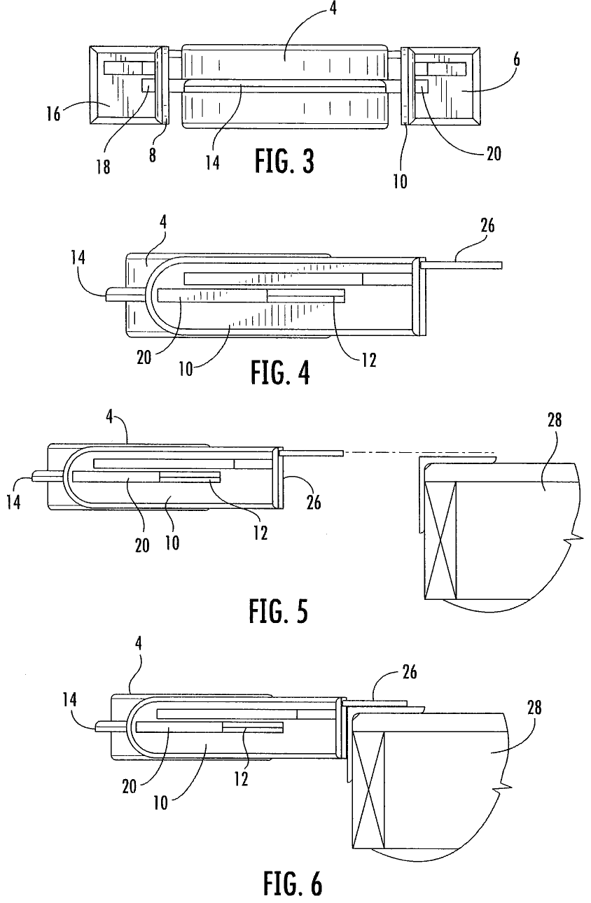

FIGS. 1-6 show an adjustable pile guide 2 according to an embodiment of the invention. The pile guide comprises a cylinder 4 through which a pile extends when in use. The cylinder is positioned within and held by bracket 6. In this embodiment, the bracket comprises a backing plate 16 that is adjacent to a dock or floating object. Opposing wings 8,10 extend outwardly from the backing plate. Each opposing wing has a slot 12 therein. A retainer, which may be a collar or retainer 14, is attached to the cylinder and positions the cylinder relative to the bracket. The retainer has flanges 18, 20 on each side of the retainer. The flanges are inserted into the slots of the wings, and are slidable within the slots to allow the distance of the cylinder to be adjusted relative to the bracket, including the backing plate.

As shown in the drawings, and in use, a center axis of the aperture of the cylinder 4 extends vertically. The cylinder has an opening that is constructed and arranged to receive a pile that is driven into the earth. The pile extends upwardly from the earth and out of a top surface of water. The pile extends through the opening in the cylinder of the pile guide 2. The cylinder has an inside diameter that is larger than the outside diameter of the pile so that the cylinder has vertical movement relative to the pile. The pile guide is mounted to a floating dock or other floating object 28. The pile and pile guide hold the floating object in its horizontal position in the water, while usually permitting vertical movement of the floating dock as water levels change.

The flanges 18,20 of the retainer are slidable within the slots. The flanges of the retainer are moved within the slots 12 of the opposing wings 8,10, which also moves the cylinder, until the backing plate 16 reaches the floating object (or a bracket attached to the floating object) and can be attached to the floating object. One or more of the plurality of spaced apart apertures 22 in the wings are aligned with one or more apertures (not shown) in the flanges 18,20 of the retainer 14. The plurality of spaced apart apertures 22 are associated with the slots, and as shown, are positioned on the wings and above the slots and the flanges. Once the distance of the pile to the floating object is established, the flanges are secured in position in the slots. In this embodiment a fastener, such as a bolt or screw 30, or a pin, is inserted through the aperture or apertures 22 in the wings that align with the aperture or apertures in the flanges. A mounting bracket 26 may be used to mount the adjustable pile guide to a floating object such as a dock. The mounting bracket as shown has a 90 degree angle, but could in some situations be a flat, vertically oriented plate that mounts to a side of a dock or floating object 28.

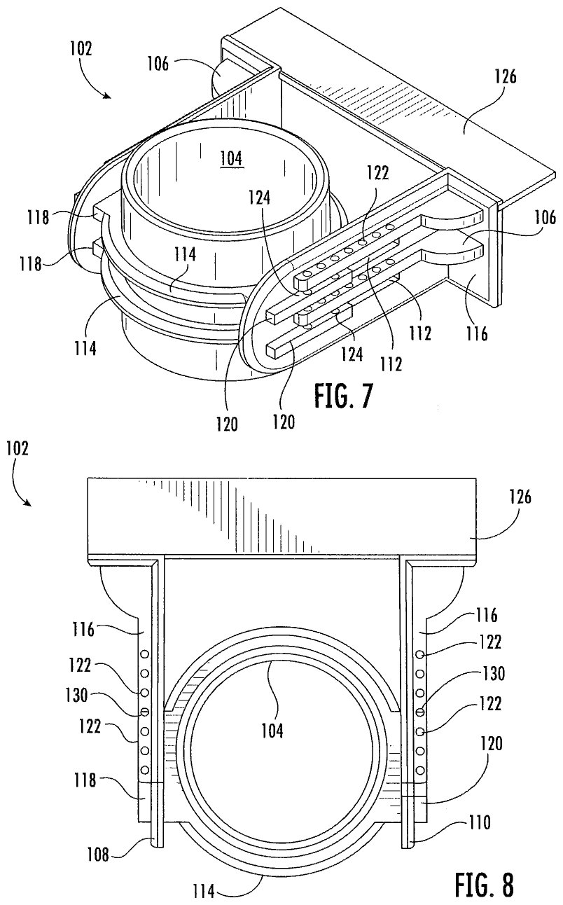

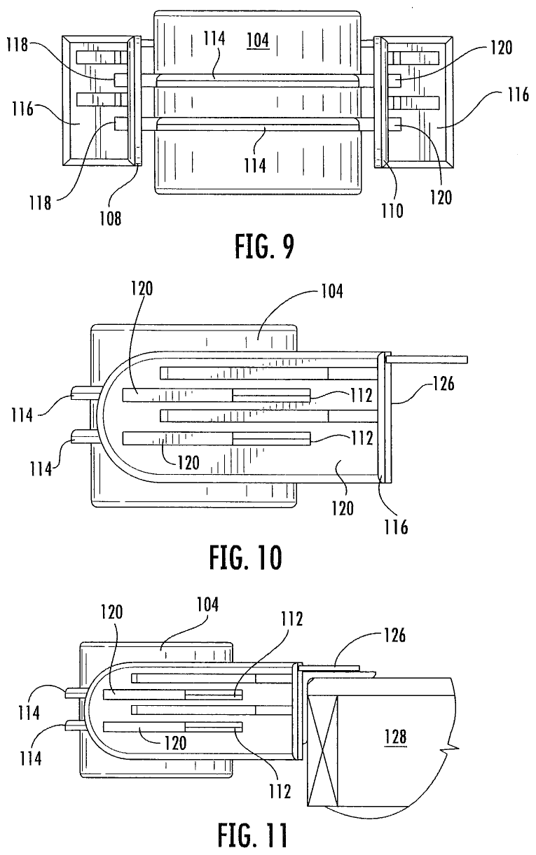

FIGS. 7-11 show an adjustable pile guide 102 according to an embodiment of the invention. The pile guide comprises a cylinder 104 through which a pile extends in use. The cylinder is positioned by bracket 106. In this embodiment, the bracket comprises a backing plate 116 that is adjacent to a dock or floating object. Opposing wings 108,110 extend outwardly from the backing plate. Each opposing wing has multiple slots 112 therein. Multiple retainers hold the cylinder in position. In this embodiment, the retainers comprise center members or collars 114 that surround the cylinder. Each retainer has flanges 118,120 on each side of the center member of the retainer. The flanges are inserted into the slots of the wings, and are slidable within the slots to allow the distance of the retainer and cylinder to be adjusted relative to the backing plate.

Each opposing wing as shown in this embodiment has two slots 112, and two sets of apertures 122 for securing the cylinder 104 in position within bracket 106. Two collars 114 surround the cylinder, with each retainer having two flanges 118, 120 extending from opposite sides of the retainer. Each of the four flanges are retained in one of the four slots of the wings. The pile extends through the opening in the cylinder of the adjustable pile guide. The pile guide is mounted to a floating dock or other floating object 128. The pile and adjustable pile guide hold the floating dock in its horizontal position in the water, while usually permitting vertical movement of the floating dock as water levels change. The enlarged wings and multiple retainers, such as the retainers, add strength and redundancy.

The cylinder 104 and retainers 114 are moved within the slots of the opposing wings 108 and 110 until the backing plate 116 and can be attached to the floating object. The retainers are moved within the slots by the flanges 118,120 sliding within the slots in the embodiments shown in all drawings. Moving the retainers moves the attached cylinder. One or more of the plurality of spaced apart apertures 122 in the wings are aligned with one or more of the multiple apertures 124 in the flanges 118, 120 of the retainers. The plurality of spaced apart apertures 122 are associated with the slots 112, and as shown, are positioned on the wings and above the slots and the flanges. Once the distance of the pile to the floating object is established, the four flanges are secured in position relative to the four slots. In this embodiment a fastener 130, such as a bolt or screw, or a pin, is inserted through the aperture or apertures in the wings that align with the aperture or apertures in the flanges. Mounting bracket 126 may be used to mount the adjustable pile guide to a floating object such as a dock.

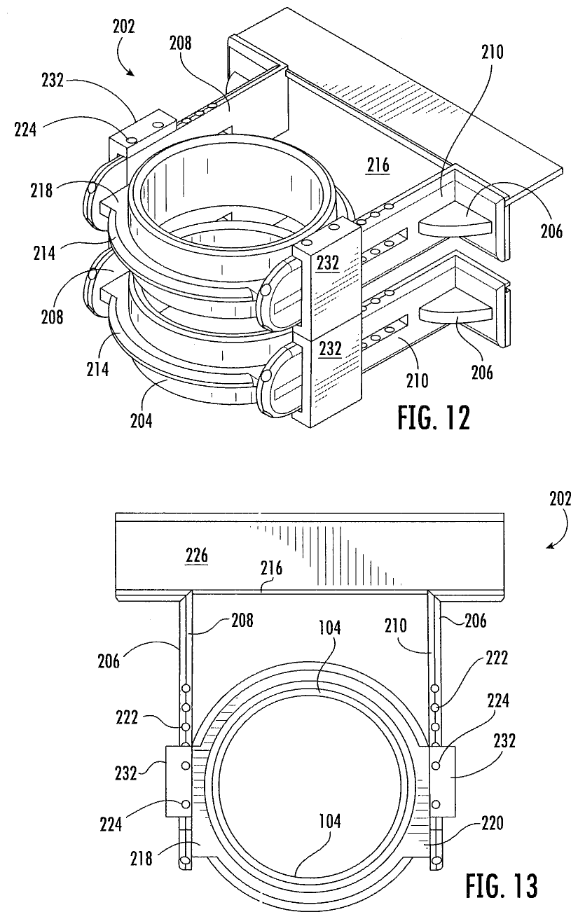

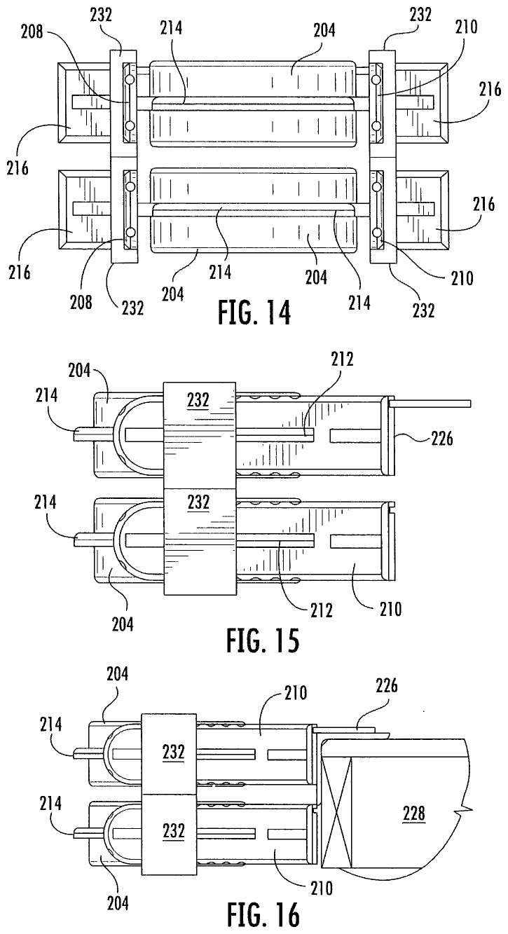

FIGS. 12 through 16 show an adjustable pile guide 202 according to an embodiment of the invention. The pile guide comprises multiple cylinders 204 through which a pile extends in use. Backing plate 216 is adjacent to the dock. Wings 208, 210 extend from each of opposing sides of the backing plate. Each of the four wings has a slot 212 therein. Retainers connect each cylinder to the wings. The retainer may comprise center members such as collars 214 that surround each cylinder. Each retainer has a flange 218, 220 on each side of the retainer. The flanges are inserted into the slots 212 of the wings. The flanges are slidable within the slots to allow the distance of the retainers and cylinders to be adjusted relative to the floating object 228.

Pile guide 202 is mounted to a floating dock or other floating object 228. The pile and adjustable pile guide hold the floating dock in its horizontal position in the water, while usually permitting vertical movement of the floating dock as water levels change. The cylinder has an inside diameter that allows movement of pile guide relative to the pile.

With a pile in position within the cylinders, the flanges 218,220 of the retainers 214 are moved within the slots 212 of the wings 208,210 until the backing plate 216 reaches the floating object 228 and can be attached to the floating object. In this embodiment, sliders 232 are attached to the flanges 218, 220 of the retainers. The sliders move along an outside surface of the wings. Other embodiments as described above could have sliders for movement of the retainers and cylinders.

One or more of the plurality of spaced apart apertures 224 in the sliders are aligned with one or more of the plurality of apertures 222 in wings. The plurality of apertures in the wings may be formed in the tops of the wings. The apertures are aligned with the apertures in the sliders, such as the tops of the sliders. Once the distance of the pile to the floating object is established, the flanges are secured in position relative to the slots. A fastener, such as a bolt or screw, or a pin, is inserted through the aligned aperture or apertures 222,224 in the sliders and the wings. A mounting bracket 226 may be used to mount the adjustable pile guide to a floating object such as a dock.

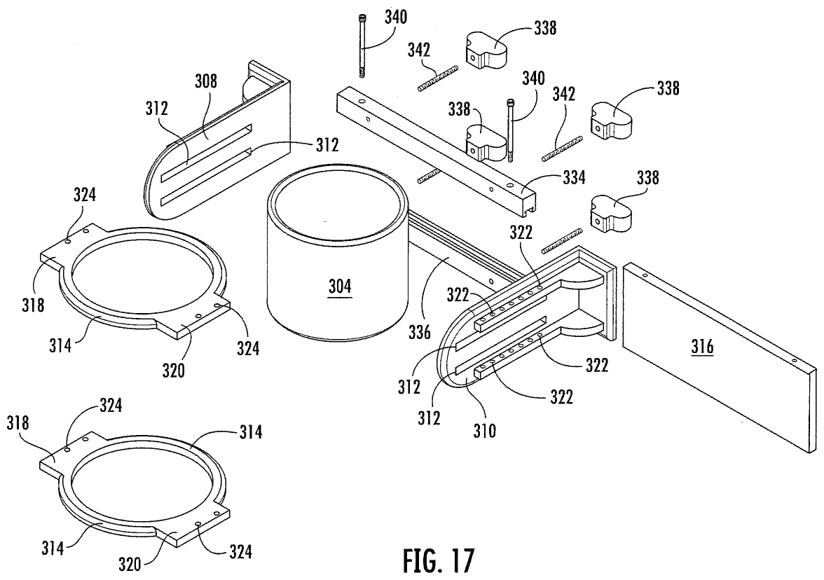

FIG. 17 is an exploded view of an embodiment of the pile guide that is similar to the embodiment of FIGS. 7 through 11. This embodiment of the pile guide 302 has a backing plate 316 with a top and bottom mounting bar 334, 336. The backing plate is positioned between the top and bottom mounting bar, and may be attached with fasteners 340. Wings 308, 310 are mounted to the backing plate that is mounted to a floating object. Mounts 338 may be attached to the floating object, and the top and bottom bar and/or the backing plate may be attached to the mounts with fasteners 342. In the embodiment shown, multiple retainers 314 for the cylinder are shown. The retainers surround the cylinder 304 in this embodiment. Flanges 318,320 of the retainers are inserted in the slots 312 and slide within the slots to adjust the distance between the retainers and cylinder and the floating object. Fasteners such as a screw or a pin may be used to hold the retainers and cylinder in place once the distance between the pile and the dock is accounted for by inserting fastener(s) in apertures in the aligned apertures 322, 324 in the flanges 308, 310.

The wings in each embodiment may be L shaped with gussets between the sides forming the L. The gussets add strength to the wings. The wings are in a generally vertical orientation in each embodiment, that is, the height is substantially greater than the width, with a slot or slots formed in the wings. The slots permit the flanges of the retainer to slide within the slots to allow generally horizonal movement of the cylinder. The slots are formed as elongated voids in the wings in the embodiments shown. The formation of the slots as shown results in slots that are closed on each end, and on top and bottom, to keep the retainer within the wings.

The retainer is preferred to have a center member, with the flanges extending from the center member on opposite sides of the center member. The center member surrounds the cylinder to hold the cylinder. The cylinder could have cross section that is not round depending on the application. A rectangular pile could use a rectangular cylinder.

The pile guide in all embodiments is preferred to be formed of thermoplastic and even more preferred to be formed of polyethylene or high-density polyethylene. High density polyethylene is impact resistant, has a low coefficient of friction and permits the flanges to slide easily within the slots of the adjustable pile guide. The pile guide may be formed of other impact resistant plastics or thermoplastics, such as medium density polyethylene. The mounting bracket may be formed of corrosion resistant materials. Thermoplastic such as polyethylene or high-density polyethylene, as well as aluminum or stainless steel, which are corrosion resistant in water and saltwater, may be used as preferred according to the application.

What is claimed:

1. A pile guide construct for floating docks, comprising:
a cylinder having a central aperture therein,
a retainer that is connected to the cylinder, the retainer having a flange extending from each of opposing sides of the retainer, and
a first wing and a second wing, the wings positioned on opposite sides of the cylinder, the first wing and the second wing extending outwardly and generally parallel to each other, each wing having a slot formed therein, the flanges of the retainer positioned within and slidable within the slots of the wings.

2. A pile guide construct for floating docks as described in claim 1, wherein the first wing and the second wing each have a connector that corresponds to a connector in each of the flanges of the retainer and the connectors hold the retainer and cylinder in position.

3. A pile guide construct for floating docks as described in claim 1, wherein the first wing and the second wing each have a plurality of apertures formed therein, the plurality of apertures constructed and arranged to align with an aperture of each of the flanges.

4. A pile guide construct for floating docks as described in claim 1, wherein, in use, the cylinder extends above the planar flanges and below the planar flanges.

5. A pile guide construct for floating docks as described in claim 1, further comprising a backing plate, and wherein the first wing and the second wing are connected to the backing plate.

6. A pile guide construct for floating docks as described in claim 1, wherein, in use, the distance of the cylinder from the bracket is adjusted by sliding the planar flanges within the apertures of the wings to a desired distance of the cylinder from the bracket.

7. A pile guide construct for floating docks as described in claim 1, wherein the retainer and the cylinder are formed as unitary members.

8. A pile guide construct for floating docks as described in claim 1, further comprising a second retainer that is connected to the cylinder, the second retainer having a flange extending from each of opposing sides of the second retainer, the first and second wings each having two slots formed therein, wherein each of the flanges of the first retainer and the second retainer is positioned in one of the slots of the first wing or the second wing, and the retainer and the second retainer are slidable within the slots.

9. A pile guide construct for floating docks as described in claim 1, wherein the slots in the wings are constructed and arranged to limit horizontal movement of the flanges sliding within the slots and retain the flanges within the slots.

10. A pile guide construct for floating docks as described in claim 1, wherein the retainer comprises a center member that surrounds the cylinder, with the flanges extending from opposite sides of the center member.

11. A pile guide construct for floating docks as described in claim 1, wherein the slots in the wings are closed on opposite ends to limit horizontal movement of the flanges sliding within the slots.

12. A pile guide construct for floating docks as described in claim 1, further comprising a slider attached to a flange of the retainer.

13. A pile guide construct for floating docks as described in claim 1, further comprising a slider attached to a flange of the retainer, the slider constructed and arranged to move along an outside surface of a wing.

14. A pile guide construct for floating docks as described in claim 1, further comprising a slider attached to a flange of the retainer, the slider constructed and arranged to move along an outside surface of a wing, the slider having an aperture formed therein constructed and arranged to align with an aperture formed in the wing.

15. A pile guide construct for floating docks as described in claim 1, wherein the wings are L shaped.
